(19) United States
(12) Patent Application Publication
(10) Pub. No.: US 2026/0167810 A1
(43) Pub. Date: Jun. 18, 2026

(54) POST-CONSUMER RESIN AND EXTRUSION COATING COMPOSITION

(71) Applicant: Braskem S.A., Camaçari (BR)

(72) Inventors: Leonardo Batista Ito, São Paulo City (BR); Marcelo Farah, São Paulo (BR); Regina Funck Nonemacher, São Paulo (BR)

(73) Assignee: Braskem S.A., Camaçari (BR)

(21) Appl. No.: 19/418,626

(22) Filed: Dec. 12, 2025

Related U.S. Application Data
(60) Provisional application No. 63/733,348, filed on Dec. 12, 2024.

(51) Int. Cl. C08L 23/06; C08J 5/18; C08J 11/06; C09D 123/06

(52) U.S. Cl. CPC C08L 23/06; C08J 5/18; C08J 11/06; C09D 123/06; C08J 2323/06; C08J 2423/06; C08L 2203/16; C08L 2205/025; C08L 2207/066; C08L 2207/20

(57) ABSTRACT

The present invention relates to a post-consumer resin (PCR), which has a polyethylene-based PCR (PE-PCR), in which the PE-PCR has recycled low-density polyethylene (LDPE) and recycled linear low-density polyethylene (LLDPE), and in which the resin is free of gels having a size greater than 1001 μm.

### BACKGROUND

Polymeric waste materials often include various raw materials such as paper, aluminum and several polymers such as different blends of polyolefins. Many of these polymers are present in waste as coating for substrates, such as paper and aluminum foil to form internal or external layers of different packaging materials. Carton packaging and other polymeric waste materials represent a particular challenge in recycling due to their diverse combinations of materials.

Recycling polymeric waste materials may include the separation of these materials from other contaminants through processes including mechanical/physical separation processes such as depulping, removal of paper, delamination, extrusion, and sequential filtration and chemical separation processes such as chemical dissolution of selective materials, and chemical extraction. Recycled polymer materials obtained from such separation processes are usually prone to contamination and may also include impurities, leading to formation of gels and other defects during film production. Thus, recycled polymers obtained from such separation processes are generally unsuitable for being used as raw materials in film production.

In polymeric coating production, such as in carton packaging products, elimination or reduction of gels during film production phase is paramount, as such defects may lead to tearing or breakage of the film during the high-speed production process. Furthermore, presence of gels may contribute to inferior aesthetics of the product or negatively affect barrier protection properties of the packaging. In particular, polymers suitable for the use in carton package production require specific rheological and physical properties in order to allow stable coating/lamination processes which may be conducted at a high line speed and production rate.

Accordingly, there exists a need for improved post-consumer polymer compositions produced from recycled materials, such as polymeric coating material, polymeric films and other waste-derived products.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An embodiment of the present invention relates to a post-consumer resin (PCR), comprising a polyethylene-based PCR (PE-PCR), wherein the PE-PCR comprises recycled low-density polyethylene (LDPE) and recycled linear low-density polyethylene (LLDPE), and wherein the resin is substantially free of gels.

Another embodiment of the present invention relates to the PCR herein, wherein no gels of Category C4 are detected within at least one measured film area of at least 1 m².

Another embodiment of the present invention relates to the PCR herein, wherein no gels of Category C3 are detected within at least one measured film area of at least 1 m².

Another embodiment of the present invention relates to the PCR herein, wherein the number of Category C2 gels is less than about 100 points/m² within at least one measured film area.

Another embodiment of the present invention relates to the PCR herein, wherein the number of Category C2 gels is less than 50 points/m², preferably less than 15 points/m² within at least one measured film area.

Another embodiment of the present invention relates to the PCR herein, wherein Category C1 gels may be present within at least one measured film area.

Another embodiment of the present invention relates to the PCR herein, wherein the number of Category C1 gels is less than 200 points/m², more preferably less than 100 points/m², and most preferably less than 50 points/m² within at least one measured film area.

Another embodiment of the present invention relates to the PCR herein, wherein the PE-PCR comprises LDPE in an amount of 1 to 99.9 wt. % and LLDPE in an amount of 1 to 99.9 wt. %, based on the total weight of the PE-PCR.

Another embodiment of the present invention relates to the PCR herein, wherein the PE-PCR comprises LDPE in an amount of 10 to 50 wt. % and LLDPE in an amount of 60 to 90 wt. %, based on the total weight of the PE-PCR.

Another embodiment of the present invention relates to the PCR herein, wherein the PE-PCR has a melt flow index in a range of 0.5 g/10 min to 12.0 g/10 min at 190° C. and 2.16 kg.

Another embodiment of the present invention relates to the PCR herein, wherein the PE-PCR is obtained from a source selected from an extrusion coating composition, plastic waste compositions, waste-derived compositions, or combinations thereof.

Another embodiment of the present invention relates to the PCR herein, wherein the extrusion coating composition is derived from a layer of a carton packaging.

Another embodiment of the present invention relates to the PCR herein, wherein the PE-PCR is obtained from flexible plastic in waste-derived compositions.

Another embodiment of the present invention relates to the PCR herein, wherein the PE-PCR is obtained from a material that has previously underwent recycling techniques.

Another embodiment of the present invention relates to the PCR herein, wherein the PE-PCR is obtained from a composition that has been purified by one or more of the following techniques:
(i) aluminum removal by alkaline treatment,
(ii) layer delamination via acid or solvent treatment, and
(iii) selective dissolution.

Another embodiment of the present invention relates to the PCR herein, wherein the aluminum removal by alkaline treatment is made using sodium hydroxide.

Another embodiment of the present invention relates to the PCR herein, wherein the selective dissolution is for dissolving polyolefins.

Another embodiment of the present invention relates to the PCR herein, wherein the selective dissolution is for dissolving impurities.

Another embodiment of the present invention relates to the PCR herein, wherein the selective dissolution is followed by one or more of precipitation, extrusion, and sequential filtration processes.

An embodiment of the present invention relates to a composition comprising the PE-PCR of claim 1.

Another embodiment of the present invention relates to the composition herein, further comprising a virgin polyethylene selected from the group comprising low-density polyethylene (LDPE), linear low-density polyethylene (LLDPE), high-density polyethylene (HDPE) or combinations thereof.

Another embodiment of the present invention relates to the composition herein, wherein the composition is an extrusion coating composition.

Another embodiment of the present invention relates to the composition herein, wherein the composition is a blown film composition.

An embodiment of the present invention relates to an article comprising a substrate coated with an extrusion coating composition comprising the PCR of claim 1.

Another embodiment of the present invention relates to the article herein, wherein the article is selected from carton packaging, coated paper and coated raffia.

An embodiment of the present invention relates to a method for producing a coated substrate, comprising extrusion coating the post-consumer resin (PE-PCR) of claim 1 onto a substrate and stretching the PE-PCR to form a coated layer.

An embodiment of the present invention relates to a method for producing a coated substrate, the method comprising:
(a) subjecting plastic waste comprising polyethylene to a dissolution step in a solvent;
(b) recovering a purified polyethylene fraction comprising LDPE and LLDPE;
(c) forming a post-consumer resin (PE-PCR) from the recovered purified fraction; and
(d) extrusion coating the PE-PCR onto a substrate and stretching the PE-PCR to provide a coated substrate;
wherein the PE-PCR is substantially free of gels.

Another embodiment of the present invention relates to the method herein, wherein the PE-PCR is stretched in air.

Another embodiment of the present invention relates to the method herein, wherein the PE-PCR is obtained from an extrusion coating composition derived from a layer of a carton packaging.

Another embodiment of the present invention relates to the method herein, wherein the PE-PCR is obtained from flexible plastic in waste-derived compositions.

Another embodiment of the present invention relates to the method herein, wherein the PE-PCR is obtained from a material that has previously underwent recycling techniques.

Another embodiment of the present invention relates to the method herein, wherein the PE-PCR is obtained from a composition that has been purified by one or more of the following techniques:
(i) aluminum removal by alkaline treatment,
(ii) layer delamination via acid or solvent treatment, and
(iii) selective dissolution.

Another embodiment of the present invention relates to the method herein, wherein the aluminum removal by alkaline treatment is made using sodium hydroxide.

Another embodiment of the present invention relates to the method herein, wherein the selective dissolution is for dissolving polyolefins.

Another embodiment of the present invention relates to the method herein, wherein the selective dissolution is for dissolving impurities.

Another embodiment of the present invention relates to the method herein, wherein the selective dissolution is followed by one or more of precipitation, extrusion, and sequential filtration processes.

Another embodiment of the present invention relates to the method herein, wherein the extrusion coating of the PE-PCR is performed through a die, with an initial film speed on the substrate typically ranging from about 150 m/min to about 750 m/min.

Another embodiment of the present invention relates to the method herein, wherein the initial film speed is from about 300 m/min to about 550 m/min.

Another embodiment of the present invention relates to the method herein, wherein the extrusion coating is conducted at a temperature in a range of from about 200° C. to about 350° C.

Another embodiment of the present invention relates to the method herein, wherein the extrusion coating is conducted at a temperature of 300, 310 or 320° C.

An embodiment of the present invention relates to a method for producing a multi-layer laminate, comprising laminating at least two substrates, wherein at least one of the substrates has been previously subjected to an extrusion coating process using the extrusion coating composition comprising the PE-PCR of claim 1.

Another embodiment of the present invention relates to the PCR herein, wherein the PCR is modified via reactive extrusion, preferably by a free-radical initiator.

Other aspects and advantages of the claimed subject matter will be apparent from the following description and the appended claims.

### BRIEF DESCRIPTION OF THE DRAWINGS

FIG. 1: rheological behavior of samples recovered from a landfill.

FIGS. 2A-2B: rough surfaces and numerous holes observed in a film made with untreated polymers.

FIG. 3: thermogravimetric analysis (TGA) of untreated polymers.

FIG. 4: elemental content of the samples after treatment.

FIGS. 5A-5B: efficiency of contaminant removal for samples with the highest and lowest initial impurity levels, respectively.

FIG. 6: rheology of treated samples exhibit a cleaner profile while maintaining characteristics similar to those of the original materials.

FIG. 7: comparison of the treated samples, regardless of their initial composition, the final materials demonstrate a consistent specification.

FIG. 8: structural analysis of the samples performed using a Van Gurp-Palmen plot.

FIG. 9: differential scanning calorimetry (DSC) showing minimal variations in composition can be observed regardless of the source material.

FIGS. 10A-10D: representative images of the films made with treated materials.

FIG. 11: significant reduction of total residues using solvent-based purification treatment to the carton packaging source.

FIG. 12: Analysis of the carton sample composition by differential scanning calorimetry (DSC).

FIG. 13: rheological analysis of the carton sample composition.

FIG. 14: structural analysis using a Van Gurp-Palmen plot compared to that of LDPE polymer.

### DETAILED DESCRIPTION

In the present description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations. Further, where a range of values is provided, it is understood that the upper and lower limit, and each intervening value between the upper and lower limit of the range is encompassed within the embodiments.

Embodiments disclosed herein generally relate to a post-consumer resin (PCR), an extrusion coating composition, an article comprising the PCR, as well as methods for producing a substrate coated by an extrusion coating composition, and for producing a multi-layer laminate. The post-consumer resin is a polyethylene-based PCR (PE-PCR) comprising recycled low-density polyethylene (LDPE) and recycled linear low-density polyethylene (LLDPE), wherein the resin is substantially free of gels having a size greater than 1001 μm.

### Post-Consumer Resin (PCR)

In one aspect, the present disclosure relates to a polyethylene-based PCR (PE-PCR) comprising recycled low-density polyethylene (LDPE) and recycled linear low-density polyethylene (LLDPE).

The term “post-consumer resin” (PCR), as used herein, denotes a polymeric material reclaimed after consumer use and reintroduced into a manufacturing cycle. For purposes of the present application, PCR encompasses polyethylene-based compositions (PE-PCR) that include recycled LDPE and LLDPE in any proportion, optionally with minor amounts of other polyolefins, such as high-density polyethylene (HDPE) or polypropylene (PP), and trace levels of non-polymeric residues. The PE-PCR may be derived from laminated or extrusion-coated articles, such as carton packages, other flexible packaging waste, or waste-derived post-consumer resin, and may be processed through any suitable recycling technique.

According to the invention, “suitable recycling techniques” or “recycling techniques” may include, but are not limited to, mechanical, thermal, chemical, or solvent-assisted methods, such as washing, drying, size reduction, chemical or solvent-based purification, or any combinations thereof. The recycling techniques of the application may optionally be followed by extrusion and/or sequential filtration to reduce both polymeric and/or non-polymeric contaminants. Examples of non-polymeric contaminants include, but are not limited to, pigments, calcium carbonate, and aluminum particles.

As used herein, the term “carton package” refers to a container formed from a composite material, such as a laminated structure comprising at least one substrate layer and one or more polymeric coating layers. The substrate may include paperboard, cardboard, metal foil, or combinations thereof, and the polymeric coating may comprise polyethylene or other thermoplastic materials. In preferred embodiments, the carton package is configured to store liquid or solid products, including food and beverage items. Examples of suitable carton packages include, without limitation, commercially available aseptic packaging systems such as those marketed by Tetra Pak and SIG.

As used herein, the term “waste-derived post-consumer resin” refers to polyethylene-based material recovered from flexible packaging waste streams. These sources typically include mixed polymer films originally used for consumer goods packaging and may contain polyethylene in major proportion, along with minor fractions of other polymers such as polypropylene (PP), polyethylene terephthalate (PET), polyamide (PA), polystyrene (PS), polyvinyl chloride (PVC), and cellulosic residues.

Prior to reuse, waste-derived resins may also undergo any suitable recycling technique.

In certain embodiments, the PE-PCR exhibits a controlled gel profile, being substantially free of gels, and may further be treated to meet regulatory requirements for food-contact applications.

As used herein, the expression “substantially free of gels” refers to a condition in which the post-consumer resin (PCR) exhibits a gel population below thresholds that would impair extrusion coating performance. For purposes of this disclosure, gels are categorized by size, as follows:

TABLE 1
Gel categories based on particle size

| Gel Category | Size | |
|---|---|---|
| C4 | >1500 | μm |
| C3 | 1001 to 1500 | μm |
| C2 | 501 to 1000 | μm |
| C1 | 210 to 500 | μm |

As per the invention, a PCR resin is considered “substantially free” of gels when no gels of Category C3 or C4 are detected within a measured film area of at least 1 m²; the number of Category C2 gels is less than about 100 points/m², preferably less than 50 points/m², and more preferably less than 15 points/m²; and Category C1 gels may be present but are preferably limited to less than 200 points/m², more preferably less than 100 points/m², and most preferably less than 50 points/m².

In an embodiment of the invention, either the carton package-derived PE-PCR and/or the waste-derived PE-PCR, include LDPE and LLDPE in any proportion, such as, for example, from 0.1 to 99.9 wt. % of LDPE and from 0.1 to 99.9 wt. % of LLDPE.

In waste-derived post-consumer resins, LDPE may be present in a range of about 1 to 50 wt. %, and LLDPE may be present in a range of about 40 to 90 wt. % based on differential scanning calorimetry (DSC) analysis. minor levels of polypropylene (PP) and high-density polyethylene (HDPE) may be present, along with trace fractions of polyethylene terephthalate (PET), polyamide (PA), polystyrene (PS), polyvinyl chloride (PVC), and cellulosic residues.

In the context of the present invention, “minor” and “minor levels” mean up to 15 wt. %, based on the total weight of the composition where such elements are present, preferably up to 10 wt. %, up to 5 wt. % or up to 1 wt. %.

In the context of the present invention, “trace” and “trace levels” mean up to 10 wt. %, based on the total weight of the composition where such elements are present, preferably up to 5 wt. % or up to 1% wt. %.

In one embodiment, the PE-PCR includes LDPE in a range from a lower value of 1, 7, 13 or 19 wt. % and an upper value of 25, 31, 37, 43 or 50 wt. %, where any lower limit may be paired with any mathematically compatible upper limit.

In another embodiment, the PE-PCR includes LLDPE in a range from a lower value of 40, 50 or 60 wt. % and an upper value of 70, 80 or 90 wt. %, where any lower limit may be paired with any mathematically compatible upper limit.

As used herein, the term “gels” refers to localized defects or non-homogeneous regions present in a film formed from a polymeric material. Gels may manifest as discrete, visually detectable irregularities that disrupt the uniformity of the film. Such defects can arise from contaminants introduced during polymer manufacture or recycling, including, but not limited to, inorganic particles, pigments, or residual non-polymeric substances. Gels may also result from polymer processing inconsistencies, such as regions of degraded resin, cross-linked fractions, or portions that exhibit insufficient melting during extrusion. Additionally, non-meltable inclusions, such as cellulose fibers, wood particles, elastomeric fragments, or other incompatible polymers, can contribute to gel formation. These defects negatively impact film aesthetics, mechanical integrity, and processability, particularly in high-speed extrusion coating operations.

In certain embodiments, the polyethylene-based post-consumer resin (PE-PCR) exhibits a melt flow index (MFI) measured at 190° C. under a 2.16 kg load in a range of about 0.5 g/10 min to about 12.0 g/10 min. In some embodiments, the MFI may fall within narrower sub-ranges, such as from a lower value of 0.5, 2.5, 4.5 or 6.5 g/10 min and an upper value of 6.5, 8.5, 10.5 or 12.5 g/10 min, where any lower limit may be paired with any mathematically compatible upper limit.

According to a preferred embodiment of the invention, the polyethylene-based post-consumer resin (PE-PCR) exhibits a melt flow index (MFI) selected from a value that provides flexibility for tailoring the resin's rheology to extrusion coating processes while maintaining adequate melt strength and processability. For example, the polyethylene-based post-consumer resin (PE-PCR) may exhibit a melt flow index (MFI) measured at 190° C. under a 2.16 kg load in a range of about 0.5 g/10 min to about 4.0 g/10 min. In some embodiments, the MFI may fall within narrower sub-ranges, such as from a lower value of 0.5, 1, 1.5 or 2 g/10 min and an upper value of 2.5, 3, 3.5 or 4 g/10 min, where any lower limit may be paired with any mathematically compatible upper limit

In one or more embodiments, the PE-PCR exhibits a melting point in a range of from about 100° C. to about 120° C., such as in a range of from a lower limit selected from any one of 100, 102, 104, 106, 108 and 110° C., to an upper limit selected from any one of 110, 112, 114, 116, 118 and 120° C., where any lower limit may be paired with any mathematically-compatible upper limit.

In certain embodiments, the polyethylene-based post-consumer resin (PE-PCR) is recovered from extrusion coating compositions originally applied as layers in carton packaging or from flexible packaging waste streams. Prior to their reuse as an extrusion coating, the recovered material may undergo suitable recycling techniques and may be further purified using one or more conventional techniques.

Examples of conventional purification techniques include, but are not limited to:
(i) aluminum removal by alkaline treatment (e.g., sodium hydroxide),
(ii) layer delamination via acid or solvent treatment, and
(iii) selective polyolefin dissolution followed by precipitation, extrusion, and sequential filtration.

In certain embodiments, purification or separation of post-consumer resin (PCR) may be achieved through solvent-assisted dissolution techniques. These processes rely on selective interaction of organic solvents with polymeric components to remove contaminants or fractionate mixed plastic streams. Suitable solvents include aliphatic and aromatic hydrocarbons, halogenated hydrocarbons, ketones, ethers, and oxygenated compounds, such as xylene, toluene, tetrahydrofuran (THF), and methylene chloride, among others.

The dissolution step may be conducted under controlled temperature conditions, typically in a range of about 20° C. to about 250° C., and for residence times from about 0.1 hour to about 24 hours, to optimize solubility behavior. In some embodiments, sequential or stepwise temperature adjustments may be employed to selectively dissolve different polymer fractions. Following dissolution, solid-liquid separation is performed by filtration or settling to remove insoluble residues, such as cellulose fibers, pigments, and aluminum particles. The dissolved polymer may then be recovered by precipitation or anti-solvent addition, followed by extrusion and sequential filtration.

Alternatively, the purification step may include dissolving impurities or incompatible components in the solvents, under controlled conditions, followed by solid-liquid separation and recovery of the polymer fraction.

### Extrusion Coating Composition

In one or more embodiments, the present invention also relates to an extrusion coating composition comprising the PE-PCR as previously defined.

According to the invention, the extrusion coating composition may further include virgin polymers. In a preferred embodiment, the virgin polymer is a polyethylene, particularly selected from low-density polyethylene (LDPE), linear low-density polyethylene (LLDPE), high-density polyethylene (HDPE) and combinations thereof.

In the context of the present disclosure, the term “virgin polymer” refers to a polymer in its original, unprocessed state, meaning it has not previously undergone any conversion or shaping operations through processing equipment such as extruders, molding machines, or similar apparatus. Virgin polymers are typically supplied as pellets or granules and have not yet been used to manufacture consumer articles.

According to the invention, the extrusion coating composition may have a PE-PCR content in a range of from about 10 wt. % to 100 wt. %, based on the total weight of the composition. For example, the PE-PCR content in the extrusion coating composition may be in a range of from a lower value of 10, 19, 28, 37, 46 or 55 wt. % and an upper value of 55, 64, 73, 82, 91 or 100 wt. %, where any lower limit may be paired with any mathematically compatible upper limit. In one or more embodiments, the extrusion coating composition consists of PE-PCR.

The PE-PCR and virgin polymer of the invention may be derived from fossil fuel, from a natural or renewable source carbon, or combinations thereof. Particularly, the natural source of carbon may include materials and compounds derived from plant materials. Preferably, such materials are derived from plants including, but not limited to, sugar cane, sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

### Article

In another aspect, the present disclosure relates to an article comprising a substrate coated with the extrusion coating composition as previously described.

According to the invention, any suitable substrate may be used. Particularly, suitable substrates include, but are not limited to, paperboard, cardboard, polymeric films, metal foil, raffia, and combinations thereof.

In certain embodiments, the article is selected from any coated substrates suitable for packaging or industrial applications. In particular, the article according to the invention is selected from a carton packaging, coated paper, and coated raffia.

### Method for Producing a Substrate Coated by the Extrusion Coating Composition

The present invention also relates to a method for producing a substrate coated by an extrusion coating composition comprising the polyethylene-based post-consumer resin (PE-PCR) as previously described.

The method according to the invention includes extrusion coating the polyethylene-based post-consumer resin (PE-PCR) onto a substrate and subsequently stretching the molten film to form a coated substrate.

Preferably, the extrusion coating is performed through a die under controlled conditions, with an initial film speed on the substrate typically ranging from about 150 m/min to about 750 m/min, and preferably from about 300 m/min to about 550 m/min, to ensure uniform coating and adhesion.

Also, according to the invention, stretching the molten film may be performed in air.

In one or more embodiments, the extrusion coating is conducted at a temperature in a range of from about 200° C. to about 350° C., such as in a range of from a lower limit selected from any one of 200, 250 and 300° C. to an upper limit selected from any one of 310, 320, and 350° C., where any lower limit may be paired with any upper limit. In one or more embodiments, the extrusion is conducted at a temperature of 300, 310 or 320° C.

### Method for Producing a Multi-Layer Laminate

In a further aspect, the present invention also relates to a method for producing multi-layer laminates. The method comprises laminating at least two substrates, wherein at least one of the substrates has been previously subjected to an extrusion coating process using the extrusion coating composition comprising the PE-PCR as previously described.

In some embodiments, each substate of the multi-layer laminate may also be coated by an extrusion coating composition as defined above.

### Blown Film Applications

In certain embodiments, the polyethylene-based post-consumer resin (PE-PCR) may be employed in blown film extrusion processes to produce flexible films suitable for packaging and industrial applications.

The resin may be processed using conventional blown film equipment, such as an extruder with a circular die, under conditions adapted to the rheological properties of the PE-PCR. Typical operating parameters include melt temperatures in the range of about 180° C. to about 220° C., blow-up ratios (BUR) from about 2:1 to about 3:1, and film thicknesses from about 20 m to about 100 m.

The resulting films may exhibit adequate mechanical strength, tear resistance, and optical properties for use in bags, liners, or secondary packaging.

In some embodiments, the blown film may consist entirely of PE-PCR or may include blends with virgin resins to optimize processability and performance.

### Methods

The following methods and technics were used for analyzing the samples of the inventions in the Examples below:

TABLE 2
Standards and methods used for analysis
performed in the application

| Analysis | Standard | OBS |
|---|---|---|
| DSC | ASTM | Heating up to 200° C. at 10° C./min holding |
| | D3418 | 5 min, cooling at 20° C./min and new |
| | | heating at 10° C./min up to 300° C. |
| DSR | ASTM | Oscillatory Rheology 100 Pa, 190° C. and |
| | D4440 | tests was from 0.0625 rad/s to 500 rad/s. |
| FRX | Internal | Based on ASTM D-6247, ASTM E 1361 and |
| | | ASTM E 1621 |
| TGA | ASTM | From 20 to 1000° C. at 20°/min |
| | 1131 | |
| Siropad(NIR) | Internal | 100 g dispersed at 0.12 m² table. |
| Film | Internal | 40-50 micros at 210° C. in a Leonard Blow |
| production | | film extruder, 30 mm screw diameter, |
| | | 60 mm annular die, 1.2 mm thick, blow |
| | | ratio 2.5. |
| Gels | Internal | OCS optical extruder and detection, AT |
| Counting | | 200° C., cooled at calendaring, at 40 |
| | | microns. |

The methodology for determining gel content involves producing a thin flat film using a laboratory-scale extruder operating at approximately 30 rpm. The film is formed with a nominal thickness of about 50 m (±10 m) and a width of about 150 mm, at a melt temperature of approximately 195° C. During extrusion, the film is subjected to a tension force of about 4.5 N and cooled on a chill roll moving at about 3 m/min. The film passes through an optical detection system equipped with a light sensor to identify and count defects.

The measurement is performed over a total film area of either 1 m² or 3 m², depending on the initial gel density. For films comprising 100% post-consumer resin (PCR) with a high gel count (greater than 4,000 gels), the evaluation area is 1 m²; for films with fewer than 4,000 gels, the evaluation area is expanded to 3 m². The optical system records the size and number of gels during a test period of approximately 2.5 minutes and normalizes the data to the measured area. This methodology can be implemented using commercially available equipment, such as an OCS optical control system equipped with an optical camera.

For the below Examples, four different waste-derived samples were collected by Brazilian cooperatives from landfills in different regions and operational conditions. This original source is a mixture of rigids and flexibles, which cover a wide range of different physical and chemical characteristics. The flexibles were selected for the present examples and comprise a mixture of PP, PE, PVC, EVA, PS, PET films. Those materials were defined as “flexibles” in prior sorting and selection made by the cooperatives. Some waste treatment cooperatives also work with automatized machinery selection, which may result in different quality and purity of the source materials.

For recycling, all samples were submitted to a washing process to remove organic and dirty materials, then dried and compacted.

TABLE 3
Source of consumer products used in the present application

| | | | Origin and |
|---|---|---|---|
| Name | Source | Origin | Characteristics |
| Cartonate | Carton aseptic | Alto Vale | Milk and beverages |
| | packages | Celulose | after depulping process |
| Landfill #1 | General flexibles | Estre-Paulínia | Semi-mechanized |
| Landfill #2 | General flexibles | CTR | Semi-mechanized |
| Landfill #3 | General flexibles | CTR | Semi-mechanized |
| Landfill #4 | General flexibles | Estre-Paulínia | Semi-mechanized |

For the cartonate sample, milk and beverage packages were manually collected, grinded and submitted to a depulping process (friction process with water in a trommel, removing paper from the mixture). The final composition is a mixture of the internal plastic part and the aluminum foil contained in the original packages. The paper removal led to an increase in plastic content from an original amount of about 25 wt. % plastic to almost 50 wt. %.

### EXAMPLES

### Example 01

The source samples were grinded and analyzed at a Siropad (NIR equipment) to define the general composition before extrusion compositions:

TABLE 4
Initial composition of the samples
(in wt. %, based on the total weight of the composition)

| | Landfill #1 | Landfill #2 | Landfill #3 | Landfill #4 |
|---|---|---|---|---|
| PE | 99.01 | 69.60 | 80.60 | 88.40 |
| PEPT | 0.71 | 11.70 | 3.30 | 6.35 |
| PP | 0.09 | 9.60 | 6.30 | 3.30 |
| PA | 0.05 | 0.31 | 1.25 | 0.80 |
| PS | 0.08 | 2.15 | 0.76 | 0.29 |
| PET | 0.02 | 4.48 | 2.40 | 0.10 |
| PVC | 0.03 | 0.90 | 0.66 | 0.46 |
| PLA | 0.00 | 0.43 | 0.40 | 0.05 |
| CLLS | 0.01 | 0.83 | 4.33 | 0.25 |
| | 100 | 100 | 100 | 100 |

As it might be observed, the quality level and composition of the original material vary depending on the source and facilities.

Other characteristics observed in the films include the presence of filler mixtures incorporated into the plastics, either to achieve specific functional properties or to reduce production costs. These additives can significantly influence the performance of the films.

The presence of such fillers poses a real challenge for maintaining desirable properties, particularly mechanical strength and optical opacity. To assess this impact, an extruded sample obtained after blending was analyzed using thermogravimetric analysis (TGA) to determine mass loss. The results are presented in Table 5.

TABLE 5
TGA Residues from original samples

| | Original TGA residues |
|---|---|
| Landfill #1 | 5.75% |
| Landfill #2 | 3.10% |
| Landfill #3 | 4.20% |
| Landfill #4 | 2.10% |

A deeper analysis was performed using X-ray fluorescence (FRX) to obtain the elemental composition of selected samples, providing additional information to complement the TGA data. The results are summarized in Table 6.

TABLE 6
Elemental Composition by XRF Analysis
(Selected landfill samples; values in ppm)

| | Landfill #1 | Landfill #4 |
|---|---|---|
| Ti | 3571 | 2836 |
| Ca | 21593 | 21330 |
| Si | 680 | 560 |
| P | 177 | 178 |
| Mg | 735 | 858 |
| Al | 361 | 332 |
| Fe | 339 | 346 |
| S | 301 | 266 |
| Cl | 1946 | 507 |
| Zn | 129 | 128 |
| K | 305 | 135 |
| Na | 523 | 560 |
| Pb | 31 | 22.3 |
| Cr | 0 | 14 |
| | 30691 | 28072.3 |

It can be observed that the main contaminant is calcium (Ca), most likely originating from supermarket bags, which may contain up to 45% calcium carbonate in their final composition. These bags are often mixed with flexible packaging and automatically detected as polyethylene during sorting. Other elements, such as chlorine (Cl), may derive from polymers like PVC, while titanium (Ti) is typically associated with white pigments used in films. Overall, the results are consistent with structures commonly found in market applications.

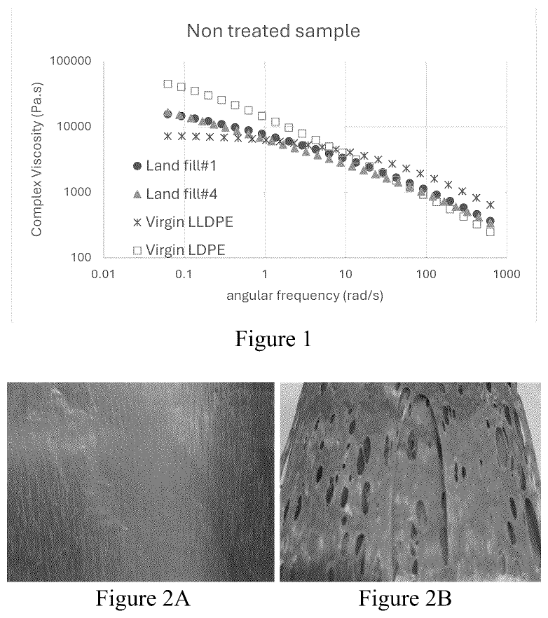

The rheological behavior of these samples is illustrated in FIG. 1, which shows the complex viscosity profile obtained through oscillatory rheology measurements.

Based on the final composition measurements, the material appears to be predominantly a blend rich in LDPE and LLDPE. Other polymers present in the mixture can be considered as “fillers” or contaminants, as indicated by the rheological curves. Overall, the behavior suggests a melt flow index (MFI) of approximately 1 g/10 min, with an estimated ratio of about 70/30 LLDPE to LDPE.

However, attempts to produce blown films from these samples, even after implementing a drying step to address hygroscopic contaminants, resulted in poor-quality films. The films exhibited rough surfaces and numerous holes, as illustrated in FIGS. 2A-2B.

### Example 02

The samples were subjected to a solvent-based dissolution process. In summary, the process involves contacting the mixed plastics with one or more solvents to selectively dissolve individual polymers or polymer pairs, followed by recovery.

This process enables selective removal of contaminants by first dissolving polymers that are more easily solubilized, such as LDPE and LLDPE, while leaving other polyolefinic polymers, such as HDPE and PP, as insoluble residues. The procedure includes removing the insoluble fraction, precipitating the dissolved polymer using an anti-solvent, and subsequently pelletizing the recovered material after solvent removal.

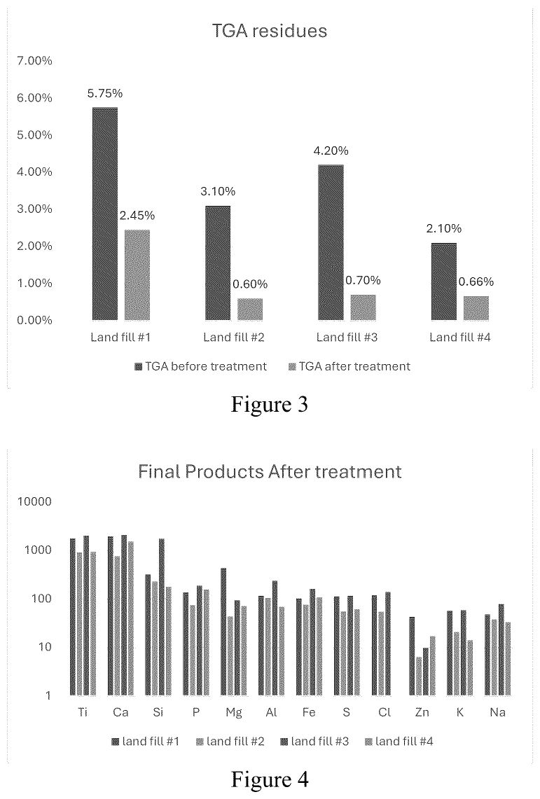

The treated pellets obtained from this process were analyzed by thermogravimetric analysis (TGA) to determine total mass loss. The results are illustrated in FIG. 3.

The results indicate a significant improvement in the removal of solid contaminants, thereby enhancing the potential for producing high-quality films.

A comparison of the elemental content of the samples after treatment is shown in FIG. 4.

The overall concentration of inorganic elements decreased substantially following the purification process, consistent with the reduction observed in the TGA analysis.

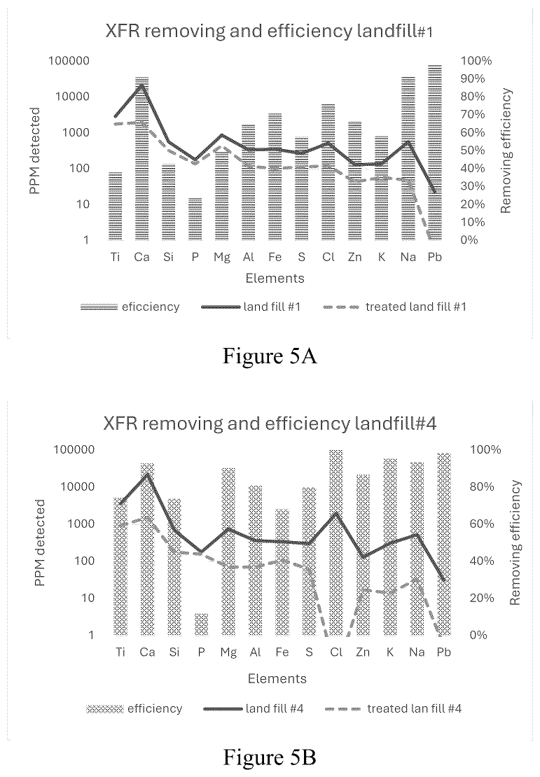

A comparison of the efficiency of contaminant removal for samples with the highest and lowest initial impurity levels is presented in FIGS. 5A and 5B.

As confirmed by XRF elemental analysis and TGA results, the filler content was substantially reduced by the purification process, resulting in films with significantly improved transparency.

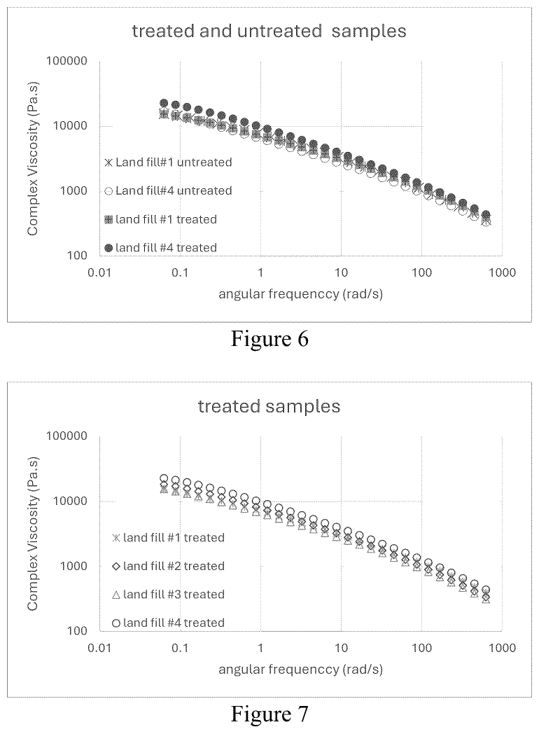

In terms of rheology, the treated samples exhibit a cleaner profile while maintaining characteristics similar to those of the original materials. This behavior is illustrated in FIG. 6.

When comparing only the treated samples, regardless of their initial composition, the final materials demonstrate a consistent specification, as shown in FIG. 7.

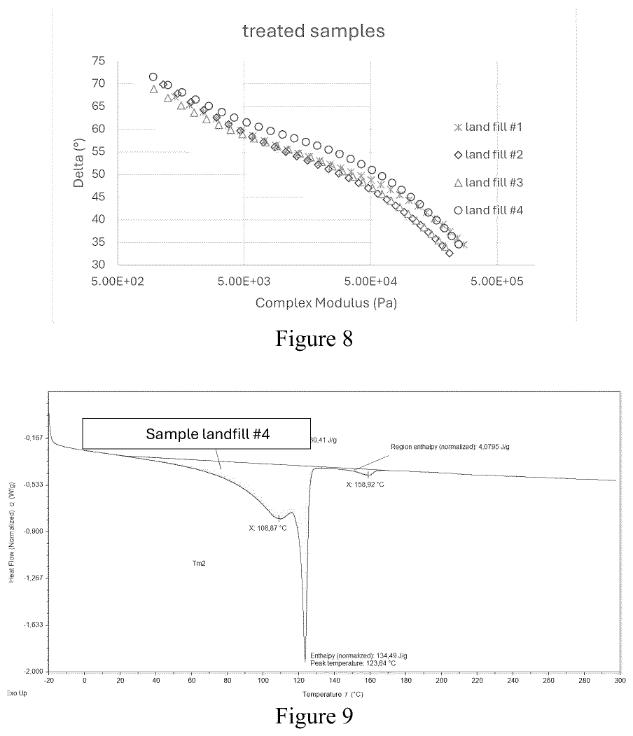

A more detailed structural analysis of the samples was performed using a Van Gurp-Palmen plot, as shown in FIG. 8.

This analysis highlights an important aspect of the compositions of the present invention: regardless of variations in the original source material, the final product can achieve a narrow and consistent specification range.

Based on differential scanning calorimetry (DSC) results, minimal variations in composition can be observed depending on the source material. These results are illustrated in FIG. 9.

Internally, the relation between the melting peaks at approximately 108 to 109° C. and 123 to 125° C. provides a direct indication of the relative amounts of LLDPE and LDPE present in the PCR mixture.

TABLE 7
Estimated Composition and Thermal Properties of PCR Samples
(Based on DSC Analysis)

| | landfill l#1 | landfill l#2 | landfill l#3 | landfill l#4 |
|---|---|---|---|---|
| Tm2 (/C.) | 109, 124 | 109, 123 | 109, 124 | 108, 123 |
| DH (J/g) | 110 | 137 | 134 | 134 |

Component estimation

| | | | | |
|---|---|---|---|---|
| LLDPE | 80% | 55% | 73% | 68% |
| LDPE | 15% | 40% | 20% | 22% |
| PP | 5% | 5% | 7% | 10% |

These data confirm that the samples represent a mixture within a range of approximately 20 to 40% LDPE content.

The quality of the film obtained after treatment is significantly improved, presenting a promising opportunity for high-performance applications.

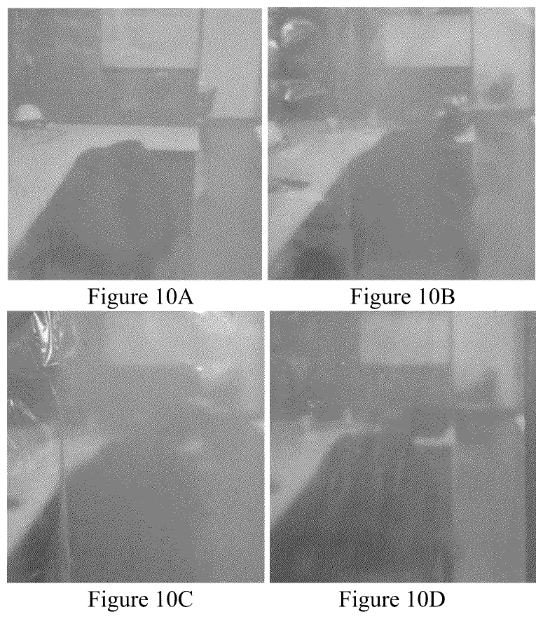

Representative images of the resulting films are shown in FIGS. 10A-10D.

Characterization of these films indicates their suitability for further evaluation using OCS (Optical Control System) methodology for gel detection and quality assessment.

TABLE 8
Gel Count per Category for Treated Films
(Measured using OCS methodology; values
expressed as number of points per m²)

| | Category 1 | Category 2 | Category 3 | Category 4 |
|---|---|---|---|---|
| Landfill #1 | 2,763 | 51 | 0 | 0 |
| Landfill #2 | 1,461 | 9 | 0 | 0 |
| Landfill #3 | 1,403 | 9 | 0 | 0 |
| Landfill #4 | 1,395 | 7 | 0 | 0 |
| Specification* | <5,000 | <250 | <3 | <1 |

*Specification refers to Braskem's reverse logistics standards.

In general, the absence of large gels (Categories 3 and 4) is a critical observation, as it indicates high material quality. Additionally, the low counts for Category 1 and Category 2 gels confirm that the films exhibit excellent surface integrity. It is worth noting that Landfill #1 showed higher opacity due to residual contaminants, which may have caused minor interference in the gel counting process.

Regardless of the numerical results being within specification limits, the treated films demonstrate superior quality compared to those obtained through highly controlled reverse logistics processes.

It is noted that minor variations in gel counts may be attributed to color interference during OCS detection.

### Example 03

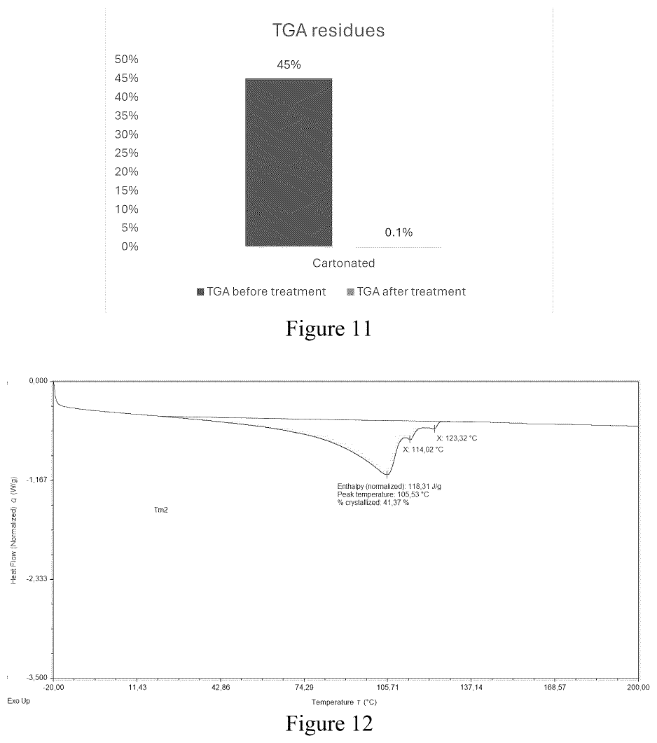

Applying the same solvent-based purification treatment to the carton packaging source also resulted in significant reduction of total residues, as illustrated in FIG. 11.

Elemental analysis of the treated carton packaging samples was performed using XRF, and the results are summarized in Table 9.

TABLE 9
Elemental Composition by XRF Analysis
(Carton packaging sample; values in ppm)

| Element | Detected (ppm) |
|---|---|
| Ti | 61.3 |
| Ca | 206.7 |
| Si | 62 |
| P | 65.7 |
| Mg | 16 |
| Al | 75.7 |
| Fe | 18 |
| S | 7.3 |
| Cl | 9 |
| Zn | 4 |
| K | 0 |
| Na | 33 |
| Pb | 0 |
| | 558.7 |

Most of the residue detected by TGA in the carton packaging sample corresponds to aluminum from the multilayer structure foil. The total residual content in the sample is significantly lower compared to typical flexible packaging, making carton packaging a promising source for recycling.

Analysis of the sample composition by differential scanning calorimetry (DSC) indicates that it is primarily composed of LDPE, with a small amount of LLDPE present. These results are shown in FIG. 12.

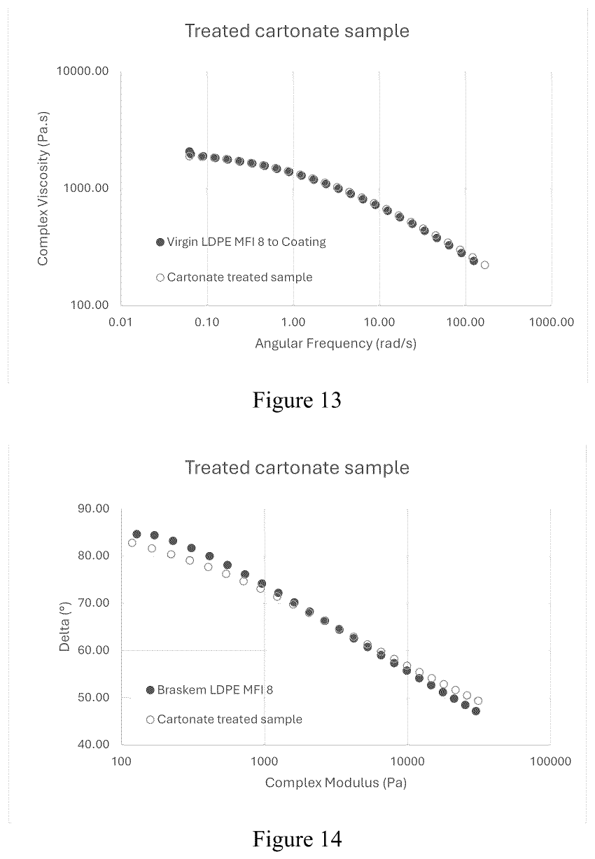

This composition was further confirmed by rheological analysis, as illustrated in FIG. 13.

The results not only confirm the production of a high-purity PCR sample but also demonstrate the potential to reuse polyethylene coating resin in the same application, based on its favorable rheological properties.

More specifically, structural analysis using a Van Gurp-Palmen plot reveals a profile very similar to that of LDPE polymers, as shown in FIG. 14.

Applying the solvent-based purification process to carton packaging sources resulted in a significant reduction of filler content, as indicated in the comparative data presented in Table 10.

TABLE 10
Gel Count for Virgin Coating Grade vs. Treated Carton Packaging Sample
(Measured using OCS methodology; values
expressed as number of points per m²)

| | Category | Category | Category | Category |
|---|---|---|---|---|
| | 1 | 2 | 3 | 4 |
| Usual virgin coating | ≤150 | ≤5 | 0 | 0 |
| grade | | | | |
| Cartonated treated | 455 | 3 | 0 | 0 |
| sample | | | | |

As it might be seen, the cartonated treated sample presents gels levels that are compatible with its coating application. These achieved properties are advantageous for applications requiring closed-loop coating processes.

The characteristics above make the material suitable for extrusion coating, even under demanding rheological conditions. Importantly to note is that the presence of a gel count that is greater than the usual for virgin coating grades is expected and does not render the material unprocessable by itself, nor does it preclude its use in blends with virgin materials.

1. A post-consumer resin (PCR), comprising a polyethylene-based PCR (PE-PCR), wherein the PE-PCR comprises recycled low-density polyethylene (LDPE) and recycled linear low-density polyethylene (LLDPE), and wherein the resin is substantially free of gels.

2. The PCR of claim 1, wherein no gels of Category C4 are detected within at least one measured film area of at least 1 m² and/or no gels of Category C3 are detected within the at least one measured film area.

3. (canceled)

4. The PCR of claim 1, wherein a number of Category C2 gels is less than about 100 points/m² within at least one measured film area.

5. (canceled)

6. The PCR of claim 1, wherein Category C1 gels is present within at least one measured film area, and wherein a number of Category C1 gels is less than 200 points/m² within the at least one measured film area.

7. (canceled)

8. The PCR of claim 1, wherein the PE-PCR comprises LDPE in an amount of 1 to 99.9 wt. % and LLDPE in an amount of 1 to 99.9 wt. %, based on a total weight of the PE-PCR.

9. (canceled)

10. (canceled)

11. The PCR of claim 1, wherein the PE-PCR is obtained from a source selected from an extrusion coating composition, plastic waste compositions, waste-derived compositions, or combinations thereof.

12. The PCR of claim 11, wherein the extrusion coating composition is derived from a layer of a carton packaging, and/or from flexible plastic in waste-derived compositions.

13. (canceled)

14. (canceled)

15. The PCR of claim 1, wherein the PE-PCR is obtained from a composition that has been purified by one or more of the following techniques:
(i) aluminum removal by alkaline treatment,
(ii) layer delamination via acid or solvent treatment, and
(iii) selective dissolution.

16. (canceled)

17. The PCR of claim 15, wherein the selective dissolution is for dissolving polyolefins or for dissolving impurities.

18. (canceled)

19. (canceled)

20. A composition comprising the PE-PCR of claim 1.

21. The composition of claim 20, further comprising a virgin polyethylene selected from the group comprising low-density polyethylene (LDPE), linear low-density polyethylene (LLDPE), high-density polyethylene (HDPE) or combinations thereof.

22. The composition of claim 20, wherein the composition is an extrusion coating composition or a blown film composition.

23. (canceled)

24. An article comprising a substrate coated with an extrusion coating composition comprising the PCR of claim 1, optionally wherein the article is selected from carton packaging, coated paper and coated raffia.

25. (canceled)

26. A method for producing a coated substrate, comprising extrusion coating the post-consumer resin (PE-PCR) of claim 1 onto a substrate and stretching the PE-PCR to form a coated layer.

27. A method for producing a coated substrate, the method comprising:
(a) subjecting plastic waste comprising polyethylene to a dissolution step in a solvent;
(b) recovering a purified polyethylene fraction comprising LDPE and LLDPE;
(c) forming a post-consumer resin (PE-PCR) from the recovered purified fraction; and
(d) extrusion coating the PE-PCR onto a substrate and stretching the PE-PCR to provide a coated substrate;
wherein the PE-PCR is substantially free of gels.

28. (canceled)

29. The method of claim 27, wherein the PE-PCR is obtained from an extrusion coating composition derived from a layer of a carton packaging, from flexible plastic in waste-derived compositions, and/or is obtained from a material that previously underwent recycling techniques.

30. (canceled)

31. (canceled)

32. (canceled)

33. (canceled)

34. The method of claim 27,
wherein the PE-PCR is obtained from a composition that has been purified by one or more of the following techniques:
(i) aluminum removal by alkaline treatment,
(ii) layer delamination via acid or solvent treatment, and
(iii) selective dissolution, and
wherein the selective dissolution is for dissolving polyolefins and/or for dissolving impurities.

35. (canceled)

36. (canceled)

37. The method of claim 27 wherein the extrusion coating of the PE-PCR is performed through a die, with an initial film speed on the substrate typically ranging from about 150 m/min to about 750 m/min and/or at a temperature in a range of from about 200° C. to about 350° C.

38. (canceled)

39. (canceled)

40. (canceled)

41. A method for producing a multi-layer laminate, comprising laminating at least two substrates, wherein at least one of the substrates has been previously subjected to an extrusion coating process using an extrusion coating composition comprising the PE-PCR of claim 1.

42. The PCR of claim 1, wherein the PCR is modified via reactive extrusion, optionally by a free-radical initiator.
